(19) United States
(12) Patent Application Publication
(10) Pub. No.: US 2007/0293395 A1
(43) Pub. Date: Dec. 20, 2007

(54) Use of 2-Substituted Pyrimidines for Combating Nematode Diseases of Plants

(75) Inventors: Henry Van Tuyl Cotter, Raleigh, NC (US); Mark R. Schmitt, Madison, WI (US)

Correspondence Address: HUTCHISON LAW GROUP PLLC, PO BOX 31686, RALEIGH, NC, 27612, US

(73) Assignee: BASF Aktiengesellschaft, Ludwigshafen (DE)

(21) Appl. No.: 11/662,992

(22) PCT Filed: Sep. 19, 2005
(86) PCT No.: PCT/EP05/10083

§ 371 Date: Mar. 15, 2007

Related U.S. Application Data
(60) Provisional application No. 60/610,608, filed on Sep. 17, 2004.

(51) Int. Cl. A01N 43/54; A01N 25/26; A01P 5/00

(52) U.S. Cl. 504/100; 514/275

(57) ABSTRACT

The invention relates to the use of 2-substituted pyrimidines of formula (I), wherein R¹, R², R³, R⁴ and X have the meanings as defined in the description; for combating nematode diseases of plants, a method for the protection of plants from attack or infestation by nematode pests which comprises applying to the foliage, shoot, root, or seed of the plants, or to the soil or water in which they are, an effective amount of compounds of formula (I).

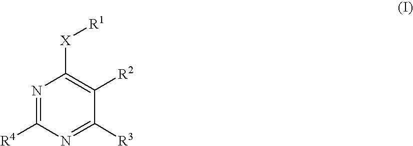

### DESCRIPTION

The invention relates to a method of use of 2-substituted pyrimidines of formula I 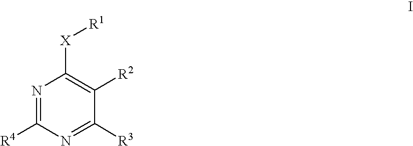
in which
R¹ denotes hydrogen or C₁-C₁₀-alkyl, C₂-C₆-alkenyl, C₂-C₆-alkynyl, C₁-C₁₀-haloalkyl, C₃-C₈-cycloalkyl, phenyl, or 5- or 6-membered heteroaryl or 5- or 6-membered heterocyclyl, containing one to four nitrogen atoms or one to three nitrogen atoms and one sulfur or oxygen atom, which radicals may be unsubstituted or may carry one to three R^{a1} radicals;
X denotes O, S, NR^{A1} or a single bond, wherein R^{A1} is hydrogen or C₁-C₁₀-alkyl, or
   R¹ and R^{A1} together with the interjacent atom form a 5- or 6-membered optionally substituted heterocyclic ring, containing one to four nitrogen atoms or one to three nitrogen atoms and one sulfur or oxygen atom,
   wherein
   R^{a1} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl, containing one to four nitrogen atoms or one to three nitrogen atoms and one sulfur or oxygen atom;
R² denotes C₃-C₆-cycloalkyl, phenyl or 5- or 6-membered heteroaryl, containing one to four nitrogen atoms or one to three nitrogen atoms and one sulfur or oxygen atom, which radicals may be unsubstituted or may carry one to three groups R^{a2}, wherein
   R^{a2} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl, containing one to four nitrogen atoms or one to three nitrogen atoms and one sulfur or oxygen atom;
R³ denotes halogen, C₁-C₁₀-alkyl, C₁-C₆-alkoxy, C₁-C₆-alkylthio, C₁-C₆-alkylamino, di-C₁-C₆-alkylamino, which radicals may be unsubstituted or may carry one to three groups R^{a3}, wherein
   R^{a3} is halogen, nitro, cyano, hydroxy, C₁-C₆-alkyl, C₃-C₈-cycloalkyl, C₁-C₆-haloalkyl, C₁-C₆-alkoxy, C₁-C₆-alkoxycarbonyl, phenyl, halo- or dihalophenyl or 5- or 6-membered heteroaryl, containing one to four nitrogen atoms or one to three nitrogen atoms and one sulfur or oxygen atom;
R⁴ is NR^{A4}(CN), wherein
   R^{A4} is hydrogen, or C₁-C₁₀-alkyl, C₂-C₆-alkenyl or C₂-C₆-alkynyl, which radicals may be unsubstituted or may carry one to three R^{a4} radicals, wherein
      R^{a4} is C₁-C₆-alkyl, C₃-C₆-cycloalkyl, C₄-C₆-cycloalkenyl, C₁-C₆-haloalkyl, C₃-C₆-halocycloalkyl or C₁-C₆-alkoxycarbonyl,
         for combating nematode diseases of plants.

Moreover, the invention relates to a method for the protection of plants from attack or infestation by nematode pests which comprises applying to the foliage, shoot, root or seed of the plants, or to the soil or water in which they are, an effective amount of compounds of formula I.

Nematode pests destroy crops including growing, harvested and dormant crops. In spite of the commercial pesticides available today, damage to crops still occurs. Accordingly, there is ongoing research to create new and more effective pesticides.

It is, therefore, an object of the present invention to provide a method for combating nematode diseases of plants.

We have found that this object is achieved by the compounds defined at the outset. Furthermore, we have found a method for combating nematode diseases of plants and a method for the protection of plants from attack or infestation by nematode pests which comprises applying to the foliage, shoot, root or seed of the plants, or to the soil or water in which they are, an effective amount of compounds of formula I.

2-Substituted pyrimidines are generally known from WO 01/96314. The compounds disclosed in this document discussed above are active against various phytopathogenic fungi.

Compounds of formula I can be prepared by the methods disclosed the document cited above.

In the symbol definitions given in formula I above, collective terms were used which generally represent the following substituents:
halogen: fluorine, chlorine, bromine or iodine;
C₁-C₁₀-alkyl and the alkyl moieties of C₁-C₁₀-alkoxy, C₁-C₁₀-alkylthio, C₁-C₁₀-alkyloxycarbonyl, C₁-C₁₀-alkylamino or di-(C₁-C₁₀-alkyl)amino: saturated, straight-chain or branched hydrocarbon radicals having 1 to 10, preferably 1 to 6 carbon atoms, especially 1 to 4 carbon atoms, such as methyl, ethyl, propyl, 1-methylethyl, butyl, 1-methylpropyl, 2-methylpropyl, 1,1-dimethylethyl, or pentyl, 1-methylbutyl, 2-methylbutyl, 3-methylbutyl, 2,2-di-methylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl;
C₁-C₁₀-haloalkyl and the haloalkyl moieties of C₁-C₁₀-haloalkoxy: straight-chain or branched alkyl groups having 1 to 10 carbon atoms, preferably 1 to 6 carbon atoms, especially 1 to 4 carbon atoms (as mentioned above), where the hydrogen atoms in these groups may be partially or fully replaced by halogen atoms as mentioned above, for example C₁-C₂-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl;
C₂-C₆-alkenyl: unsaturated, straight-chain or branched hydrocarbon radicals having 2 to 6, preferably 2 to 4 carbon atoms, and a double bond in any position, especially C₃-C₄-alkenyl, for example ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl and 2-methyl-2-propenyl;
C₂-C₆-alkynyl: straight-chain or branched hydrocarbon radicals having 2 to 6, preferably 2 to 4 carbon atoms, and a triple bond in any position, especially C₃-C₄-alkynyl, for example ethynyl, 1-propynyl, 2-propynyl, 1-butynyl, 2-butynyl, 3-butynyl and 1-methyl-2-propynyl;
C₃-C₈-cycloalkyl: mono- or bicyclic hydrocarbon radicals having 3 to 10 carbon atoms; monocyclic groups having 3 to 8, especially 3 to 6 ring members, for example C₃-C₈-cycloalkyl such as cyclopropyl, cyclobutyl, cyclopentyl, cyclohexyl, cycloheptyl and cyclooctyl;
C₃-C₈-halocycloalkyl: mono- or bicyclic hydrocarbon radicals having 3 to 10 carbon atoms; monocyclic groups having 3 to 8, especially 3 to 6 ring members (as mentioned above), where the hydrogen atoms in these groups may be partially or fully replaced by halogen atoms as mentioned above;
C₃-C₈-cycloalkenyl: unsaturated, mono- or bicyclic hydrocarbon radicals having 3 to 10 carbon atoms; monocyclic groups having 3 to 8, especially 3 to 6 ring members, and a double bond in any position;
5- or 6-membered heterocycle: homo- or bicyclic hydrocarbon radicals containing one to four heteroatoms selected from the group consisting of a nitrogen atom, an oxygen atom and a sulfur atom; unsaturated (heterocyclyl) includes partially unsaturated, e.g. mono-unsaturated, and aromatic (heteroaryl); said heterocycles in particular include:
5-membered heteroaryl, containing one to four nitrogen atoms or one to three nitrogen atoms and one sulfur or oxygen atom: 5-membered heteroaryl groups which, in addition to carbon atoms, may contain one to four nitrogen atoms or one to three nitrogen atoms and one sulfur or oxygen atom as ring members, for example 2-furyl, 3-furyl, 2-thienyl, 3-thienyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 2-imidazolyl, 4-imidazolyl, 1,2,4-oxadiazol-3-yl, 1,2,4-oxadiazol-5-yl, 1,2,4-thiadiazol-3-yl, 1,2,4-thiadiazol-5-yl, 1,2,3-triazol-4-yl, 1,2,4-triazol-3-yl, tetrazolyl, 1,3,4-oxadiazol-2-yl, 1,3,4-thiadiazol-2-yl and 1,3,4-triazol-2-yl;
6-membered heteroaryl, containing one to four nitrogen atoms: 6-membered heteroaryl groups which, in addition to carbon atoms, may contain one to three or one to four nitrogen atoms as ring members, for example 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,2,3-triazinyl, 1,3,5-triazin-2-yl and 1,2,4-triazin-3-yl.
5- and 6-membered heterocyclyl, containing one to four nitrogen atoms or one to three nitrogen atoms and one sulfur or oxygen atom: 3-pyrazolidinyl, 4-pyrazolidinyl, 5-pyrazolidinyl, 2-pyrrolodin-2-yl, 2-pyrrolodin-3-yl, 3-pyrrolodin-2-yl, 3-pyrrolodin-3-yl, 1-piperidinyl, 2-piperidinyl, 3-piperidinyl, 4-piperidinyl, pyridin(1,2-dihydro)-2-on-1-yl, 2-piperazinyl, 1-pyrimidinyl, 2-pyrimidinyl, morpholin-4-yl, thiomorpholin-4-yl.

With respect to their intended use, preference is given to 2-substituted pyrimidines of formula I having the following substituents, where the preference is valid in each case on its own or in combination:

Compounds of formula I are preferred in which X is a bond and R¹ denotes halogen, hydroxy, straight-chained or branched C₁-C₁₀-alkyl, C₃-C₈-cycloalkyl, C₁-C₁₀-haloalkyl or phenyl, phenyl being optionally substituted by one to three halogen, hydroxy, C₁-C₆-alkyl or C₁-C₆-alkoxy groups.

Preference is given to compounds I in which X is NR^{A1}, R^{A1} is hydrogen or C₁-C₁₀-alkyl, and R¹ is hydrogen, C₁-C₆-alkyl, C₄-C₆-alkenyl, C₁-C₆-haloalkyl, C₅-C₆-cycloalkyl or phenyl, which radicals may be substituted by one to three halogen or C₁-C₆-alkyl.

If R¹ denotes C₁-C₁₀-haloalkyl or, preferably, a polyfluorinated alkyl group (with X preferably being a bond, or even more preferably NR^{A1} with R^{A1} especially being hydrogen), the 2,2,2-trifluoroethyl, 2-(1,1,1-trifluoropropyl) or 2-(1,1,1-trifluorobutyl) group is particularly preferred.

Particular preference is given to compounds I in which X is NR^{A1} and R¹ and R^{A1} together with the interjacent atom form a 5- or 6-membered heterocyclic ring, containing one to four nitrogen atoms or one to three nitrogen atoms and one sulfur or oxygen atom, preferably an optionally substituted heterocyclic ring bonded via a nitrogen atom to the pyrimidine moiety, in particular a pyrrolidine or piperidine, such as a piperidin-1-yl or morpholinyl ring; substituents on said heterocyclic ring especially include one or more C₁-C₁₀-alkyl, preferably C₁-C₄-alkyl groups.

Besides, preference is given to compounds I in which R² is phenyl which may be substituted by halogen, especially chloro or fluoro, C₁-C₄-alkyl, C₁-C₄-alkoxy or C₁-C₂-haloalkyl, wherein at least one substituent is in ortho position.

Moreover, preference is given to compounds I in which R² is a group G: 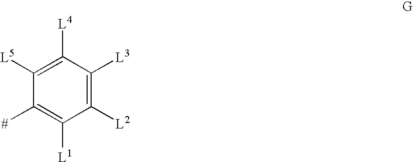
wherein L¹ to L⁵ independently denote hydrogen, halogen, methyl or methoxy, and # marks the bond to the pyrimidine system, wherein at least one of L¹ to L⁵ is not hydrogen.

Particular preference is given to compounds I in which L¹ and/or L⁵ is not hydrogen.

Furthermore, particular preference is given to compounds I in which R² is a group G1: 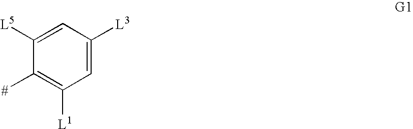
wherein
L¹ is halogen, methyl or methoxy;
L³ is hydrogen, halogen, methyl or methoxy; and
L⁵ is hydrogen, halogen or methyl.

Moreover, preference is given to compounds I, wherein R² is a phenyl group which is substituted by one to three radicals R²:
R^{a2} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl, containing one to four nitrogen atoms or one to three nitrogen atoms and one sulfur or oxygen atom.

Particular preference is given to compounds of formula I in which R³ is halogen, methoxy or thiomethyl, especially chloro.

Besides, particular preference is given to compounds I in which R³ represents a chloro atom.

Particular preference is given to compounds of formula I in which R⁴ is N(CN)R^{A4}, R^{A4} being hydrogen, C₁-C₄-alkyl or C₂-C₄-alkenyl.

Included in the scope of the present invention are (R) and (S) isomers of compounds of general formula I having a chiral center and the racemates thereof, and salts, N-oxides and acid addition compounds.

Most preferred are the compounds compiled in the following tables:

TABLE I
Compounds of formula I:

| | |
|---|---|
| | I |
| 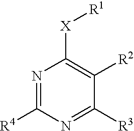 | |

| | X | R¹ | R^{A1} | R² | R³ | R⁴ |
|---|---|---|---|---|---|---|
| I-1 | NR^{A1} | —(CH₂)₂CH(CH₃)(CH₂)₂— | | 2-Cl, 6-F—C₆H₃ | Cl | —NHCN |
| I-2 | NR^{A1} | —CH₂CF₃ | H | 2-Cl, 6-F—C₆H₃ | Cl | —N(CN)CH₂CH═CH₂ |
| I-3 | NR^{A1} | —CH(CH₃)₂ | H | 2,4,6-F₃—C₆H₂ | Cl | —N(CH₃)CN |
| I-4 | NR^{A1} | —(CH₂)₂CH(CH₃)(CH₂)₂— | | 2,4,6-F₃—C₆H₂ | Cl | —N(CH₃)CN |
| I-5 | NR^{A1} | —CH(CH₃)CF₃ | H | 2,4,6-F₃—C₆H₂ | Cl | —N(CH₃)CN |

I-5 is a chiral compounds having S-configuration on the R^{A1} radical

The formula I compounds of this invention are useful for the control of plant parasitic nematodes and the plant diseases that they cause. These include plant parasitic nematodes such as root-knot nematodes, Meloidogyne arenaria, Melopidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes; Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species.

In practice, generally 0.1 ppm to 10 000 ppm and preferably 1 ppm to 5000 ppm of formula I compounds, dispersed in water or another liquid carrier, is effective when applied to plants (foliage, shoot and/or root), seeds or the soil or water in which the plants are growing or are to be grown to protect the plants from nematode attack and infestation.

The compounds I are also effective for protecting plants from attack or infestation by nematodes when applied to the foliage, shoot or roots of the plants and/or to the soil or water in which said plants are growing or are to be grown in sufficient amount to provide a rate of 0.01 kg/ha to 100 kg/ha, preferably from 0.1 to 3.0 kg/ha, of active ingredient.

In the treatment of seed, amounts of active ingredient are from 0.001 to 10 g, preferably 0.01 to 1 g, are generally required per kilogram of seed.

The compounds I are usually applied in customary formulations, e.g. solutions, emulsions, suspensions, dusts, powders, pastes and granules. The use form depends on the particular purpose; in any case, it should guarantee a fine and uniform distribution of the compound according to the invention.

The formulations are prepared in a known manner, e.g. by extending the active ingredient (i.e. at least one compound of formula I) with solvents and/or carriers, if desired using emulsifiers and dispersants, it also being possible to use other organic solvents as auxiliary solvents if water is used as the diluent. Auxiliaries which are suitable are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. highly-disperse silica, silicates); emulsifiers such as non-ionic and anionic emulsifiers (e.g. polyoxyethylene fatty alcohol ethers, alkylsulfonates and arylsulfonates) and dispersants such as lignin-sulfite waste liquors and methylcellulose.

Examples of suitable surfactants include alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions include, but are not restricted to, mineral oil fractions of medium to high boiling point, such as kerosene or diesel oil, furthermore coal tar oils and oils of vegetable or animal origin, aliphatic, cyclic and aromatic hydrocarbons, e.g. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, e.g. dimethylformamide, dimethyl sulfoxide, N-methylpyrrolidone and water.

Powders, materials for scattering and dusts can be prepared by mixing or concomitantly grinding the active substances with a solid carrier.

Granules, e.g. coated granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, e.g. ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise of from 0.01 to 95% by weight, preferably from 0.1 to 90% by weight, of the active ingredient. The active ingredients are employed in a purity of from 90% to 100%, preferably 95% to 100% (according to NMR spectrum).

The formulations may contain adjuvants, such as those known from EP-A 943 241, and WO 0/018227. In such formulations formula I compounds may show an enhanced efficacy.

The active ingredient concentrations in the ready-to-use products can be varied within substantial ranges. In general, they are from 0.0001 to 10%, preferably from 0.01 to 1%.

While the formula I compounds of this invention are effective for controlling nematode diseases of agronomic and horticultural crops, and non-crop plants, when employed alone, they may also be used in combination with other biological agents used in agriculture, including other nematicides, insecticides and/or acaricides.

Mixing the compounds I or the compositions comprising them in the use form as pesticides with other pesticides frequently results in a broader pesticidal spectrum of action. For example, the formula I compounds may be used effectively in conjunction or combination with pyrethroids, phosphates, carbamates, cyclodienes, formamidines, phenol tin compounds, chlorinated hydrocarbons, benzoylphenyl ureas, pyrroles and the like. The following list of pesticides together with which the compounds according to the invention can be used, is intended to illustrate the possible combinations by way of example:

Fumigant nematicidal compounds such as chloropicrin, dazomet, 1,3-dichloropropene, ethylene dibromide, metam, methyl bromide, methyl iodide, methyl isothiocyanate, and sodium tetrathio(peroxocarbonate), carbamate nematicidal compounds such as aldicarb, carbofuran, carbosulfan, and oxamyl, organophosphate nematicidal compounds such as cadusafos, ethoprophos, fenamiphos, fosthiazate, phorate, terbufos, and triazophos, other chemical nematicidal materials, such as abamectin and benclothiaz, biological nematicidal materials such as Myrothecium verrucaria compositions, bacterial pathogens of nematodes including but not limited to Pasteuria species, fungal pathogens of nematodes, and nematode predators of nematodes;

Further organophosphates such as Acephate, Azinphos-methyl, Chlorpyrifos, Chlorfenvinphos, Diazinon, Dichlorvos, Dicrotophos, Dimethoate, Disulfoton, Ethion, Fenitrothion, Fenthion, Isoxathion, Malathion, Methamidophos, Methidathion, Methyl-Parathion, Mevinphos, Monocrotophos, Oxydemeton-methyl, Paraoxon, Parathion, Phenthoate, Phosalone, Phosmet, Phosphamidon, Phorate, Phoxim, Pirimiphos-methyl, Profenofos, Prothiofos, Sulprophos, Trichiorfon;

Further carbamates such as Alanycarb, Benfuracarb, Carbaryl, Fenoxycarb, Furathiocarb, Indoxacarb, Methiocarb, Methomyl, Pirimicarb, Propoxur, Thiodicarb, Triazamate;

Pyrethroids such as Bifenthrin, Cyfluthrin, Cypermethrin, Deltamethrin, Esfenvalerate, Ethofenprox, Fenpropathrin, Fenvalerate, Cyhalothrin, Lambda-Cyhalothrin, Permethrin, Silafluofen, Tau-Fluvalinate, Tefluthrin, Tralomethrin, Zeta-Cypermethrin;

Arthropod Growth Regulators:

a) chitin synthesis inhibitors: benzoylureas: Chlorfluazuron, Diflubenzuron, Flucycloxuron, Flufenoxuron, Hexaflumuron, Lufenuron, Novaluron, Teflubenzuron, Triflumuron; Buprofezin, Diofenolan, Hexythiazox, Etoxazole, Clofentazine;

b) ecdysone antagonists: Halofenozide, Methoxyfenozide, Tebufenozide;

c) juvenoids: Pyriproxyfen, Methoprene, Fenoxycarb;

d) lipid biosynthesis inhibitors: Spirodiclofen;

Various: Acequinocyl, Amitraz, Azadirachtin, Bifenazate, Cartap, Chlorfenapyr, Chlordimeform, Cyromazine, Diafenthiuron, Dinetofuran, Diofenolan, Emamectin, Endosulfan, Endotoxin of Bacillus thuringiensis (Bt), Fenazaquin, Fipronil, Formetanate, Formetanate Hydrochloride, Hydramethylnon, Imidacloprid, Indoxacarb, Pyridaben, Pymetrozine, Spinosad, Sulfur, Tebufenpyrad, Thiamethoxam, and Thiocyclam.

The formula I compounds may also be used in combination or conjunction with one or more other parasiticidal compounds including anthelmintics, such as benzimidazoles, piperazine, levamisole, pyrantel, praziquantel and the like; endectocides such as avermectins, milbemycins and the like; ectoparasiticides such as arylpyrroles, organophosphates, carbamates, gamabutyric acid inhibitors including fipronil, pyrethroids, spinosads, imidacloprid and the like; insect growth regulators such as pyriproxyfen, cyromazine and the like; and chitin synthase inhibitors such as benzoylureas, such as flufenoxuron.

The formula I compounds may also be used in combination or conjunction with one or more other fungicidal compounds including, but not limited to sulfur, dithiocarbamates and their derivatives, such as iron(III)dimethyldithiocarbamate, zinc dimethyldithiocarbamate, zinc ethylenebisdithiocarbamate, manganese ethylenebisdithiocarbamate, manganese zinc ethylenediaminebisdithiocarbamate, tetramethylthiuram disulfide, ammonia complex of zinc (N,N-ethylenebisdithiocarbamate), ammonia complex of zinc (N,N′-propylenebisdithiocarbamate), zinc (N,N′-propylenebisdithiocarbamate), N,N′-polypropylenebis(thiocarbamoyl)disulfide; nitro derivatives, such as dinitro(1-methylheptyl)phenyl crotonate, 2-sec-butyl-4,6-dinitrophenyl 3,3-dimethylacrylate, 2-sec-butyl-4,6-dinitrophenylisopropyl carbonate, diisopropyl 5-nitro-isophthalate; heterocyclic substances, such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)phosphinyl]-3-phenyl-1,2,4-triazole, 2,3-dicyano-1,4-dithioanthraquinone, 2-thio-1,3-dithiolo[4,5-b]quinoxaline, methyl 1-(butylcarbamoyl)-2-benzimidazolecarbamate, 2-methoxycarbonylaminobenzimidazole, 2-(2-furyl)benzimidazole, 2-(4-thiazolyl)benzimidazole, N-(1,1,2,2-tetrachloroethylthio)tetrahydrophthalimide, N-trichloromethylthiotetrahydrophthalimide, N-trichloromethylthiophthalimide, 5-chloro-2-cyano-4-p-tolyl-imidazole-1-sulfonic acid dimethylamide, N-dichlorofluoromethylthio-N′,N′-dimethyl-N-phenylsulfo-diamide, 5-ethoxy-3-tri-chloromethyl-1,2,3-thiadiazole, 2-thiocyanatomethylthiobenzothiazole, 1,4-dichloro-2,5-dimethoxybenzene, 4-(2-chlorophenylhydrazono)-3-methyl-5-isoxazolone, pyridine-2-thiol-1-oxide, 8-hydroxyquinoline or its copper salt, 2,3-dihydro-5-carboxanilido-6-methyl-1,4-oxathiine, 2,3-dihydro-5-carboxanilido-6-methyl-1,4-oxathiine 4,4-dioxide, 2-methyl-5,6-dihydro-4H-pyran-3-carboxanilide, 2-methylfuran-3-carboxanilide, 2,5-dimethylfuran-3-carboxanilide, 2-Chloro-N-(4′-chloro-biphenyl-2-yl)-nicotinamide, 2,4,5-trimethylfuran-3-carboxanilide, N-cyclohexyl-2,5-dimethylfuran-3-carboxamide, N-cyclohexyl-N-methoxy-2,5-dimethylfuran-3-carboxamide, 2-methylbenzanilide, 2-iodobenzanilide, N-formyl-N-morpholine-2,2, 2-trichloroethyl acetal, piperazine-1,4-diylbis-1-(2,2,2-trichloroethyl)formamide, 1-(3,4-dichloroanilino)-1-formylamino-2,2,2-trichloroethane; 2,6-dimethyl-N-tridecylmorpholine or its salts, 2,6-dimethyl-N-cyclododecylmorpholine or its salts, N-[3-(p-tert-butylphenyl)-2-methylpropyl]-cis-2,6-dimethyl-morpholine, N-[3-(p-tert-butylphenyl)-2-methylpropyl]-piperidine, 8-tert.-butyl-1,4-dioxaspiro[4,5]decan-2-ylmethyl(ethyl)(propyl)amine, (RS)-2-[2-(1-chlorocyclopropyl)-3-(2-chlorophenyl)-2-hydroxypropyl]-2,4-dihydro-1,2,4-triazole-3-thione, 1-[2-(2,4-dichlorophenyl)-4-ethyl-1,3-dioxolan-2-yl-ethyl]-1H-1,2,4-triazole, 1-[2-(2,4-dichlorophenyl)-4-n-propyl-1,3-dioxolan-2-yl-ethyl]-1H-1,2,4-triazole, N-(n-propyl)-N-(2,4,6-trichlorophenoxyethyl)-N′-imidazolyl-urea, 1-(4-chlorophenoxy)-3,3-dimethyl-1-(1H-1,2,4-triazol-1-yl)-2-butanone, 1-(4-chlorophenoxy)-3,3-dimethyl-1-(1H-1,2,4-triazol-1-yl)-2-butanol, (2RS,3RS)-1-[3-(2-chlorophenyl)-2-(4-fluorophenyl)-oxiran-2-ylmethyl]-1H-1,2,4-triazole, α-(4-chlorophenyl)-α-(1-cyclopropylethyl)-1H-1,2,4-triazole-1-ethanol, α-(2-chlorophenyl)-α-(4-chlorophenyl)-5-pyrimidinemethanol, 5-butyl-2-dimethylamino-4-hydroxy-6-methylpyrimidine, bis(p-chlorophenyl)-3-pyridinemethanol, 1,2-bis(3-ethoxycarbonyl-2-thioureido)benzene, 1,2-bis(3-methoxycarbonyl-2-thioureido)benzene, strobilurines such as methyl(E)-2-{2-[6-(2-cyanophenoxy)pyrimidin-4-yloxy]phenyl}-3-methoxyacrylate, (E)-2-(methoxyimino)-N-methyl-2-[α-(2,5-xylyloxy)-o-tolyl]acetamide, {2-[6-(2-chlorophenoxy)-5-fluoropyrimidin-4-yloxy]phenyl}(5,6-dihydro-1,4,2-dioxazin-3-yl)methanone O-methyloxime, methyl(E)-methoxyimino[α-(o-tolyloxy)-o-tolyl]acetate, (E)-2-(methoxyimino)-N-methyl-2-(2-phenoxyphenyl)acetamide, (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide, methyl-(E)-3-methoxy-2-{2-[6-(trifluoromethyl)-2-pyridyloxymethyl]phenyl}acrylate, methyl N-{2-[1-(4-chlorophenyl)-1H-pyrazol-3-yloxymethyl]phenyl}(N-methoxy)carbamate, methyl(E)-methoxyimino-{(E)-α-[1-(α,α,α-trifluoro-m-tolyl)ethylideneaminooxy]-o-tolyl}acetate, anilinopyrimidines such as N-(4,6-dimethylpyrimidin-2-yl)aniline, N-[4-methyl-6-(1-propynyl)pyrimidin-2-yl]-aniline, N-[4-methyl-6-cyclopropylpyrimidin-2-yl]aniline, phenylpyrroles such as 4-(2,2-difluoro-1,3-benzodioxol-4-yl)pyrrole-3-carbonitrile, cinnamamides such as 3-(4-chlorophenyl)-3-(3,4-dimethoxy-phenyl)acryloylmorpholine, 3-(4-fluorophenyl)-3-(3,4-dimethoxy-phenyl)acryloylmorpholine, and a variety of fungicides such as dodecylguanidine acetate, 3-[3-(3,5-dimethyl-2-oxycyclohexyl)-2-hydroxyethyl]glutarimide, hexachlorobenzene, methyl N-(2,6-dimethylphenyl)-N-(2-furoyl)-DL-alaninate, DL-N-(2,6-dimethylphenyl)-N-(2′-methoxyacetyl)alanine methyl ester, N-(2,6-dimethylphenyl)-N-chloroacetyl-D,L-2-amino-butyrolactone, DL-N-(2,6-dimethylphenyl)-N-(phenylacetyl)alanine methyl ester, 5-methyl-5-vinyl-3-(3,5-dichlorophenyl)-2,4-dioxo-1,3-oxazolidine, 3-[3,5-dichlorophenyl(5-methyl-5-methoxymethyl]-1,3-oxazolidine-2,4-dione, 3-(3,5-dichlorophenyl)-1-isopropylcarbamoylhydantoin, N-(3,5-dichlorophenyl)-1,2-dimethylcyclopropane-1,2-dicarboximide, 2-cyano-[N-(ethylaminocarbonyl)-2-methoximino]acetamide, 3,5-dichloro-N-(3-chloro-1-ethyl-1-methyl-2-oxo-propyl)-4-methyl-benzamide, 1-(3-dromo-6-methoxy-2-methylphenyl)-1-(2,3,4-trimethoxy-6-methyl-phenyl)-methanone, 1-[2-(2,4-dichloro-phenyl)pentyl]-1H-1,2,4-triazole, 2,4-difluoro-a-(1H-1,2,4-triazolyl-1-methyl)benzhydryl alcohol, N-(3-chloro-2,6-dinitro-4-trifluoromethylphenyl)-5-trifluoromethyl-3-chloro-2-aminopyridine, 1-((bis(4-fluorophenyl)methylsilyl)methyl)-1H-1,2,4-triazole, isopropyl 2-methyl-1-[(1-p-tolylethyl)carbamoyl]-(S)-propylcarbamate, [(S)-1-([(1R)-1-(6-fluoro-1,3-benzothiazol-2-yl)ethyl]carbamoyl)-2-methylpropyl]carbamic acid, and 6-iodo-2-propoxy-3-propyl-quinazolin-4(3H)-one.

The formula I compounds may also be used in combination or conjunction with one or more compounds selected from piperonyl butoxide, N-octyl bicycloheptene dicarboximide, dipropyl pyridine-2,5-dicarboxylate and 1,5a,6,9,9a,9b-hexahydro-4a (4H)-dibenzofurancarboxaldehyde to broaden the spectrum of activity.

The formula I compounds may also be used in combination or conjunction with one or more other herbicidal compounds including, but not limited to alloxydim, clethodim, cloproxydim, cycloxydim, sethoxydim, tralkoxydim, butroxydim, clefoxydim, tepraloxydim, clodinafop-propargyl, cyhalofop-butyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl quizalofop-tefuryl, flamprop-methyl, flamprop-isopropyl, imazapyr, imazaquin, imazamethabenz-methyl (imazame), imazamox, imazapic, imazethapyr, pyrithiobac-acid, pyrithiobac-sodium, bispyribac-sodium, KIH-6127, pyribenzoxym, amidosulfuron, azimsulfuron, bensulfuron-methyl, chlorimuronethyl, chlorsulfuron, cinosulfuron, cyclosulfamuron, ethametsulfuron-methyl, ethoxysulfuron, flazasulfuron, flucarbazone, flupyrsulfuron, foramsulfuron, halosulfuron-methyl, imazosulfuron, iodosulfuron, mesosulfuron, metsulfuron-methyl, nicosulfuron, primisulfuron-methyl, prosulfuron, procarbazone, pyrazosulfuron-ethyl, rimsulfuron, sulfometuron-methyl or -3-oxetanyl, sulfosulfuron, thifensulfuron-methyl, triasulfuron, tribenuron-methyl, triflusulfuron-methyl, trifloxysulfuron, tritosulfuron, metosulam, florasulam, flumetsulam, penoxsulfuron, cloransulam, diclosulam, allidochlor (CDAA), benzoylprop-ethyl, bromobutide, chlorthiamid, diphenamid, etobenzanid (benzchlomet), fluthiamide, fosamin, monalide, clopyralid, picloram,2,4-D, benazolin, naptalame, diflufenzopyr, benzofenap, clomazone (dimethazone), diflufenican, fluorochloridone, fluridone, pyrazolynate, pyrazoxyfen, isoxaflutole, isoxachlortole, mesotrione, sulcotrione (chlormesulone), ketospiradox, flurtamone, picolinafen, norflurazon, amitrol, glyphosate, sulfosate, bilanafos (bialaphos), glufosinate-ammonium, anilofos, mefenacet, dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor, xylachlor, butylate, cycloate, di-allate, dimepiperate, EPTC, esprocarb, molinate, pebulate, prosulfocarb, thiobencarb (benthiocarb), triallate, vernolate, benfuresate, perfluidone, asulam, carbetamid, chlorpropham, orbencarb, pronamid (propyzamid), propham, tiocarbazil, benefin, butralin, dinitramin, ethalfluralin, fluchloralin, oryzalin, pendimethalin, prodiamine, trifluralin, dithiopyr or thiazopyr, butamifos, chlorthalo-dimethyl (DCPA), maleic hydrazide, acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen, oxyfluorfen, oxadiargyl, oxadiazon, azafenidin, butafenacil, carfentrazone-ethyl, cinidon-ethyl, flumiclorac-pentyl, flumioxazin, flumipropyn, flupropacil, fluthiacet-methyl, sulfentrazone, thidiazimin, ET-751, JV 485, nipyraclofen, propanil, pyridate, pyridafol, bentazone, bromofenoxim, dinoseb, dinoseb-acetate, dinoterb, DNOC, cyperquat-chloride, difenzoquat-methylsulfate, diquat, paraquat-dichloride, chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron, tebuthiuron, bromoxynil, ioxynil, chloridazon, ametryn, atrazine, cyanazine, desmetryn, dimethamethryn, hexazinone, prometon, prometryn, propazine, simazine, simetryn, terbumeton, terbutryn, terbutylazine, trietazine, metamitron, metribuzin, bromacil, lenacil, terbacil, desmedipham, phenmedipham, tridiphane, 2,4-DB, clomeprop, dichlorprop, dichlorprop-P (2,4-DP-P), fluoroxypyr, MCPA, MCPB, mecoprop, mecoprop-P, triclopyr, chloramben, dicamba, quinclorac, quinmerac, isoxaben, dichlobenil, dalapon, ethofumesate, chlorfenac (fenac), aziprotryn, barban, bensulide, benzthiazuron, benzofluor, buminafos, buthidazole, buturon, cafenstrole, chlorbufam, chlorfenprop-methyl, chloroxuron, cin-methylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid, and trimeturon.

The compositions which may be used in the present invention comprise an amount of a formula I compound effective in protecting plants from nematodes, or combinations thereof admixed with one or more agronomically acceptable tolerable inert, solid or liquid carriers. Such compositions may comprise further additives, such as stabilizers, antifoams, viscosity regulators, binders and takifiers. Whereas commercial products will preferably be formulated as concentrates, the end user will normally employ dilute formulations.

The efficacy of the compounds of the formula I against nematode diseases of plants was demonstrated by the following experiments:

Trial 1—Greenhouse Soil Nematicide Assay Targeting Root-Knot Nematode Meloidogyne sp. on Tomato

The test compounds were solubilized in acetone and diluted with water and surfactant to the required test concentrations. The test solution was applied as a soil drench to transplanted tomato plants (variety Bonny Best) in cells with sandy loam mixed with sand. One thousand root-knot J2 larvae were applied as an aqueous suspension drenched on the soil surface later the same day as treatment. The plants were maintained in the greenhouse and, 2-3 weeks after inoculation, the plant roots were washed free of soil. The root-knot galls on the root system of each plant were counted.

Percent control of root knot was calculated for the treated plants relative to control plants treated with the acetone-surfactant carrier using the following formula:
C=100×(U−T)/U
C=% control of root knot galls
U=median number of galls on control plants
T=median number of galls on treated plants

Phytotoxicity evaluations were also made. Shoot phytotoxicity evaluations were made one week after treatment and root phytotoxicity evaluations were made when the root systems were harvested. Shoot stunting was observed for some of the compounds.

In this experiment, compounds I-1, I-3, I-4, and I-5, when applied at 10 kg/ha, respectively, provided at least about 50% control of root knot.

Trial 2—Greenhouse Soil Nematicide Assay Targeting Soybean Cyst Nematode Heterodera glycines on Soybean

The test compounds were solubilized in acetone and diluted with water and surfactant to the required test concentrations. The test solution was applied as a soil drench to transplanted soybean plants (variety Hutcheson) in cells with sandy loam mixed with sand. One thousand root-knot J2 larvae were applied as an aqueous suspension drenched on the soil surface later the same day as treatment. The plants were maintained in the greenhouse and, 4 weeks after inoculation, the nematode cysts were extracted from the root system and soil using sieves. The cysts extracted from each root-soil system were counted.

Percent control of soybean cyst was calculated for the treated plants relative to control plants treated with the acetone-surfactant carrier using the formula given above.

In this experiment, compound I-5, when applied at 10 kg/ha, provided at least 70% control of soybean cyst nematode.

1-9. (canceled)

10. A method for the protection of plants from attack or infestation by nematode pests which comprises applying to the foliage, shoot, root or seed of the plants, or to the soil or water in which they are growing, an effective amount of a 2-substituted pyrimidine of formula I 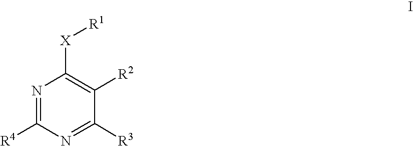
in which
R¹ denotes hydrogen or C₁-C₁₀-alkyl, C₂-C₆-alkenyl, C₂-C₆-alkynyl, C₁-C₁₀-haloalkyl, C₃-C₈-cycloalkyl, phenyl, or 5- or 6-membered heteroaryl or 5- or 6-membered heterocyclyl containing one to four nitrogen atoms or one to three nitrogen atoms and one sulfur or oxygen atom, which radicals may be unsubstituted or may carry one to three R^{a1} radicals;
X denotes O, S, NR^{A1} or a single bond, wherein R^{A1} is hydrogen or C₁-C₁₀-alkyl, or
R¹ and R^{A1} together with the interjacent atom form a 5- or 6-membered optionally substituted heterocyclic ring containing one to four nitrogen atoms or one to three nitrogen atoms and one sulfur or oxygen atom,
wherein
R^{a1} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl containing one to four nitrogen atoms or one to three nitrogen atoms and one sulfur or oxygen atom;
R² denotes C₃-C₆-cycloalkyl, phenyl or 5- or 6-membered heteroaryl containing one to four nitrogen atoms or one to three nitrogen atoms and one sulfur or oxygen atom, which radicals may be unsubstituted or may carry one to three groups R^{a2}, wherein
R^{a2} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl containing one to four nitrogen atoms or one to three nitrogen atoms and one sulfur or oxygen atom;
R³ denotes halogen, C₁-C₁₀-alkyl, C₁-C₆-alkoxy, C₁-C₆-alkylthio, C₁-C₆-alkylamino, di-C₁-C₆-alkylamino, which radicals may be unsubstituted or may carry one to three groups R^{a3}, wherein
R^{a3} is halogen, nitro, cyano, hydroxy, C₁-C₆-alkyl, C₃-C₈-cycloalkyl, C₁-C₆-haloalkyl, C₁-C₆-alkoxy, C₁-C₆-alkoxycarbonyl, phenyl, halo- or dihalophenyl or 5- or 6-membered heteroaryl containing one to four nitrogen atoms or one to three nitrogen atoms and one sulfur or oxygen atom;
R⁴ is NR^{A4}(CN), wherein
R^{A4} is hydrogen, C₁-C₁₀-alkyl, C₂-C₆-alkenyl or C₂-C₆-alkynyl, which radicals may be unsubstituted or may carry one to three R^{a4} radicals, wherein
R^{a4} is C₁-C₆-alkyl, C₃-C₆-cycloalkyl, C₄-C₆-cycloalkenyl, C₁-C₆-haloalkyl, C₃-C₆-halocycloalkyl or C₁-C₆-alkoxycarbonyl.

11. The method according to claim 10 wherein X is a single bond and R¹ denotes straight-chained or branched C₁-C₁₀-alkyl, C₃-C₈-cycloalkyl, C₁-C₁₀-haloalkyl or phenyl, phenyl being optionally substituted by one to three halogen, hydroxy, C₁-C₆-alkyl or C₁-C₆-alkoxy groups.

12. The method according to claim 10 wherein X is NR^{A1}, R^{A1} is hydrogen or C₁-C₁₀-alkyl, and R¹ is hydrogen, C₁-C₆-alkyl, C₄-C₆-alkenyl, C₁-C₆-haloalkyl, C₅-C₆-cycloalkyl or phenyl, which radicals may be substituted by one to three halogens or C₁-C₆-alkyl, or R¹ and R^{A1} together with the interjacent atom form a 5- or 6-membered heterocyclic ring containing one to four nitrogen atoms or one to three nitrogen atoms and one sulfur or oxygen atom, which ring is optionally substituted by one or more C₁-C₁₀-alkyl groups.

13. The method according to claim 10, wherein in R² is a group G: 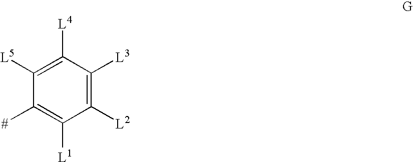
wherein L¹ to L⁵ independently denote hydrogen, halogen, methyl or methoxy, and # marks the bond to the pyrimidine system, wherein at least one of L¹ to L⁵ is not hydrogen.

14. The method according to claim 10, wherein in R² is phenyl, which is substituted by one to three radicals R^{a2}.

15. The method according to claim 10, wherein in R³ is halogen, methoxy or thiomethyl.

16. The method according to claim 15, wherein in R³ is chloro.

17. The method according to claim 10, wherein in R^{A4} is hydrogen, C₁-C₄-alkyl or C₂-C₄-alkenyl.

18. Seed, containing from 0.001 to 10 g per kilogram of seed, of a compound of formula I: 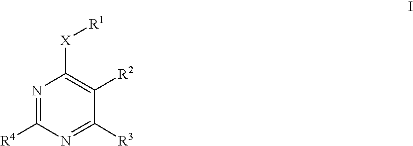
in which
R¹ denotes hydrogen or C₁-C₁₀-alkyl, C₂-C₆-alkenyl, C₂-C₆-alkynyl, C₁-C₁₀-haloalkyl, C₃-C₈-cycloalkyl, phenyl, or 5- or 6-membered heteroaryl or 5- or 6-membered heterocyclyl containing one to four nitrogen atoms or one to three nitrogen atoms and one sulfur or oxygen atom, which radicals may be unsubstituted or may carry one to three R^{a1} radicals;
X denotes O, S, NR^{A1} or a single bond, wherein R^{A1} is hydrogen or C₁-C₁₀-alkyl, or
R¹ and R^{A1} together with the interjacent atom form a 5- or 6-membered optionally substituted heterocyclic ring containing one to four nitrogen atoms or one to three nitrogen atoms and one sulfur or oxygen atom,
wherein
R^{a1} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl containing one to four nitrogen atoms or one to three nitrogen atoms and one sulfur or oxygen atom;
R² denotes C₃-C₆-cycloalkyl, phenyl or 5- or 6-membered heteroaryl containing one to four nitrogen atoms or one to three nitrogen atoms and one sulfur or oxygen atom, which radicals may be unsubstituted or may carry one to three groups R^{a2}, wherein
R^{a2} is halogen, nitro, cyano, hydroxy, C₁-C₆-alkyl, C₃-C₆-cycloalkyl, C₁-C₆-haloalkyl, C₁-C₆-alkoxy, C₁-C₆-alkoxycarbonyl, phenyl, halo- or dihalophenyl or 5- or 6-membered heteroaryl containing one to four nitrogen atoms or one to three nitrogen atoms and one sulfur or oxygen atom;
R³ denotes halogen, C₁-C₁₀-alkyl, C₁-C₆-alkoxy, C₁-C₆-alkylthio, C₁-C₆-alkylamino, di-C₁-C₆-alkylamino, which radicals may be unsubstituted or may carry one to three groups R^{a3}, wherein
R^{a3} is halogen, nitro, cyano, hydroxy, C₁-C₆-alkyl, C₃-C₈-cycloalkyl, C₁-C₆-haloalkyl, C₁-C₆-alkoxy, C₁-C₆-alkoxycarbonyl, phenyl, halo- or dihalophenyl or 5- or 6-membered heteroaryl containing one to four nitrogen atoms or one to three nitrogen atoms and one sulfur or oxygen atom;
R⁴ is NR^{A4}(CN), wherein
R^{A4} is hydrogen, C₁-C₁₀-alkyl, C₂-C₆-alkenyl or C₂-C₆-alkynyl, which radicals may be unsubstituted or may carry one to three R^{a4} radicals, wherein
R^{a4} is C₁-C₆-alkyl, C₃-C₆-cycloalkyl, C₄-C₆-cycloalkenyl, C₁-C₆-haloalkyl, C₃-C₆-halocycloalkyl or C₁-C₆-alkoxycarbonyl.
